(19) United States
(12) Patent Application Publication
(10) Pub. No.: US 2006/0225007 A1
(43) Pub. Date: Oct. 5, 2006

(54) Antenna effect prevention by model extraction in a circuit design for advanced processes

(75) Inventors: Chung-Hsing Wang, Baoshan Township (TW); Shou-Yi Lee, Yongkang City (TW); Lee-Chung Lu, Taipei (TW)

Correspondence Address: Howard Chen;Preston Gates & Ellis LLP, Suite 1700, 55 Second Street, San Francisco, CA, 94105, US

(73) Assignee: Taiwan Semiconductor Manufacturing Co.

(21) Appl. No.: 11/100,105

(22) Filed: Apr. 5, 2005

(51) Int. Cl. G06F 17/50

(52) U.S. Cl. 716/2

(57) ABSTRACT

A method is disclosed for determining an antenna ratio for an interconnect in a circuit. The interconnect may be routed through one or more connection layers and may be electrically coupled to one or more gate oxide areas. A cumulative antenna ratio for all components on each connection layer is determined by considering an antenna effect caused by each component on a predetermined connection layer with regard to the gate oxide areas coupled thereto and any components on one or more connection layers coupled between the component of the present connection layer and the gate oxide areas. In the same fashion, a top layer cumulative antenna ratio for the interconnect is determined based on the cumulative antenna ratios for the connection layers below the top layer.

### BACKGROUND

The present invention relates generally to integrated circuit designs, and more particularly to methods for preventing antenna effect with model extraction in a circuit design for advanced processes.

As integrated circuit (IC) technologies continue to advance and circuit density becomes higher, antenna effect becomes one of the important reliability issues in today's very large scale integration (VLSI) systems, especially in the routing stage of VLSI design. The antenna problem is a side effect of various plasma-based manufacturing processes such as etching. These plasma-based processes are widely used to achieve the fine feature size of modern IC.

Plasma etchers or ion implanters can induce a voltage into isolated leads, thereby overstressing the thin gate oxides. The polysilicon or metal leads act like an antenna to collect charges and the accumulated charges may result in oxide breakdown. The induced charges on metal or via during manufacturing process can damage devices. These charges may also have a negative effect on hot-carrier devices aging lifetime. Since oxides of new devices are expected to become thinner as VLSI design continues to scale up, the antenna effect is expected to be a more serious problem.

In order to reduce or eliminate antenna effect, it is found that the ratio of the physical area of the conductors such as the metal or polysilicon interconnects making up the “antenna” to the total gate oxide area to with the antenna is electrically connected should be limited so that charges will not build up so much to create the antenna effect. The occurrences of the antennas can be predicted and their ratios calculated using design verification and layout software known as “design rule check” (“DRC”) programs.

One of commonly practiced conventional methods used for reducing antenna effect is to pre-determine the antenna effect based on a per-layer and gate area ratio. By knowing the ratio of antenna effect based on a certain area, the physical layout of the interconnects of the circuit designs such as System-on-Chip (SoC) designs can be adjusted to prevent antenna effects. Such conventional method can determine the antenna effect by each layer of metal and is good for 0.18 um or above aluminum processes. However, it may not be as efficient for other types of process such as copper processes of 0.13 um, 90 nm, and below where copper processes require more layers of metal than aluminum process. As the size of metal processes becomes even smaller, the number of layers of metal will also increase.

It is therefore desirable in the art to improve the methods for determining antenna ratio for all types of processes, and for eliminating antenna effect therewith.

### SUMMARY

In view of the foregoing, this invention provides antenna models for hierarchical or cell-based design for SoC design that uses cumulative metal ratio instead of per metal layer check to determine the antenna ratio.

A method is disclosed for determining an antenna ratio for an interconnect in a circuit. The interconnect may be routed through one or more connection layers and may be electrically coupled to one or more gate oxide areas. A cumulative antenna ratio for all components on each connection layer is determined by considering an antenna effect caused by each component on a predetermined connection layer with regard to the gate oxide areas coupled thereto and any components on one or more connection layers coupled between the component of the present connection layer and the gate oxide areas. In the same fashion, a top layer cumulative antenna ratio for the interconnect is determined based on the cumulative antenna ratios for the connection layers below the top layer.

Along with these embodiments and examples, an improved technique for determining antenna ratio is possible allowing antenna effect prevention for SoC designs that utilize copper processes of 0.13, 90 nm, and below.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A illustrates a diagram of multiple metal layers used in copper processes of 0.13 um, 90 nm, and below.

FIG. 1B illustrates a first embodiment of this invention showing the calculations used for determining the cumulative antenna ratio for antenna effect of copper process within FIG. 1A.

FIG. 2 illustrates a second embodiment of this invention showing a SoC design layout demonstrating an interface antenna model used for analysis stage of top level.

FIG. 3A illustrates another diagram of multiple metal layers used in copper processes of 0.13 um, 90 nm, and below with the implementation of the interface antenna model from FIG. 2.

FIG. 3B illustrate a third embodiment of this invention showing the antenna ratio calculation for copper process within FIG. 3A resulted from using the abstract model extraction method.

### DESCRIPTION

The present invention provides methods for preventing antenna effect with model extraction in a circuit design for advanced process. For circuit design layouts, a boundary information is needed with regard to a interconnect of a circuit block, which includes the information for the antenna ratio. By appropriately identifying the antenna ratio, the DRC tools can adjust the design and reduce possible defective designs. It is understood that the antenna effect is largely related to interconnects in the circuit design, and they largely include metal interconnects or metal structures or polysilicon interconnects at this point. The following discussion uses metal interconnects or metal structures as illustration examples, and it should be understood that the present invention applies to all other types of interconnects as long as they cause the antenna effect as the metal structures. As such, the metal layers illustrated below are only examples for the connection layers of the circuit.

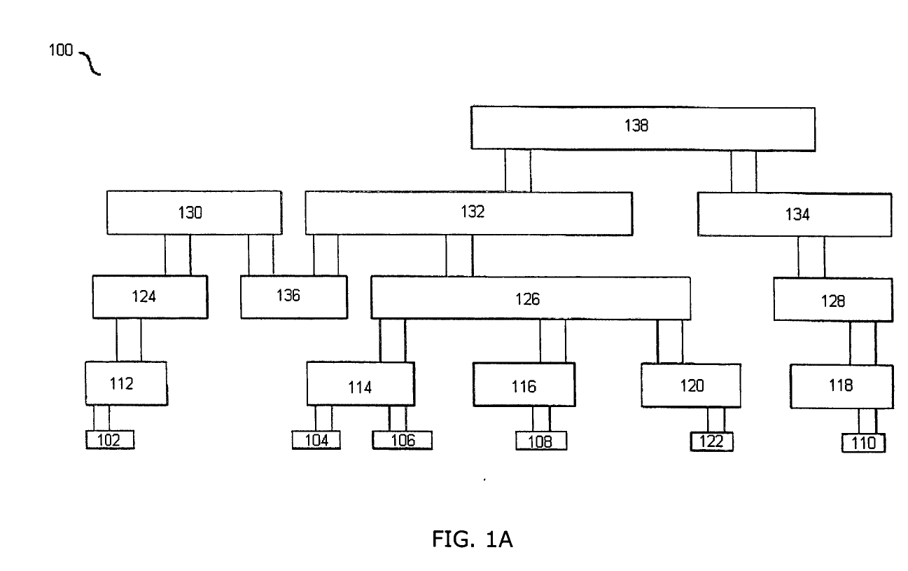

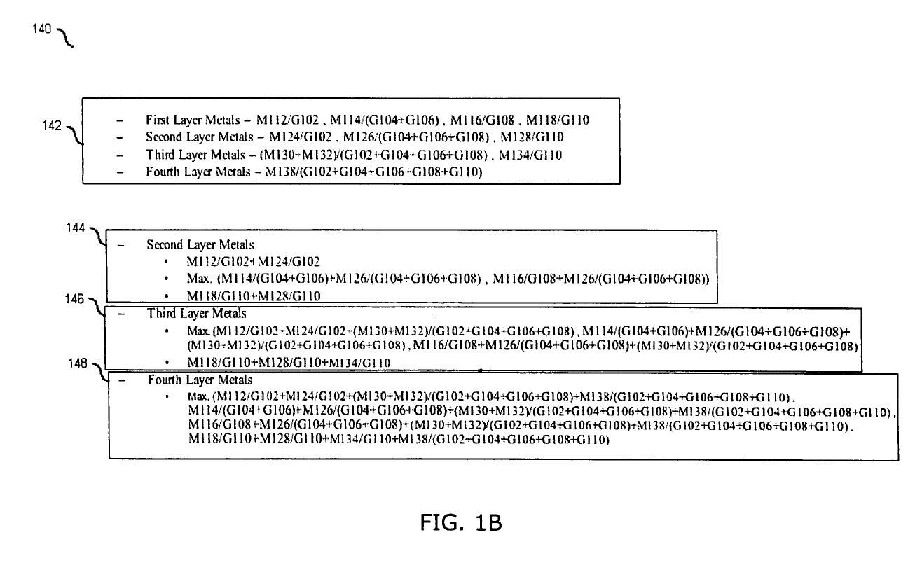

FIG. 1A presents a diagram 100 showing multiple metal layers that are used for the copper process where the process can be 0.13 um, 90 nm, or below.

The diagram 100 includes five separate gates 102, 104, 106, 108, and 110, each of which connects to one of the first layer metals 112, 114, 116, and 118. First layer metal 120 is connected to a diffusion region 122. Each of the first layer metals 112, 114, 116, 118, and 120 is then connected to one of the second layer metals 124, 126, and 128, each of which is further connected to one of the third layer metals 130, 132, and 134. The third layer metals 130 and 132 are tied directly to each other through a second layer metal 136. Both the third layer metals 132 and 134 are also connected to a fourth layer metal 138.

Since the number of metal layers for the copper process of 0.13 um, 90 nm, and below is high, the calculation of the antenna effect based on a per-layer and gate area ratio will not be efficient. According to the present invention, the antenna effect can be determined by calculating a cumulative antenna ratio for all metal layers involved.

FIG. 1B illustrates a first embodiment of the present invention with a diagram 140 showing the calculation for antenna effect of the copper structure shown in the diagram 100 of FIG. 1A by calculating the cumulative antenna ratio of the interconnect within all metal layers. As it is shown, it is determined that there are altogether four metal layers involved. Equations for each layer of metals are first derived in four equations 142, which are combined into three equation sets 144, 146, and 148 to determine the cumulative antenna ratio for the second, third, and fourth metal layers. For example, in the equation block 142, the antenna ratios for the first layer metal interconnect components are determined, e.g., M112/G102 or M114/(G104+G106), where each ratio is separately determined by the related metal area over the related gate area. It is understood that since the gate oxide area is the same size as the gate area, and the for the purpose of this invention, the uses of the gate area and the gate oxide area are interchangeable. The separately calculated antenna ratios are then recombined for the calculation of the cumulative antenna ratio for each additional metal layer of the copper structure in the diagram 100. It is noticed, that when calculating the antenna ratio for any upper metal layer, a bigger ratio is used if there are multiple routes associated with a metal structure. For example, with respect to the metal structure 126 as reflected in the equation group 144, there are two routes, one going through the metal structure 114 to reach the gates 104 and 106, while the other going through the metal structure 116 to reach the gate 108. In this case, one accumulative ratio is M114/(G104+G106)+M126/(G104+G106+G108) and the other is M116/G108+M126/(G104+G106+G108). The greater of these two is going to be selected as the antenna ratio with regard to the metal structure 126.

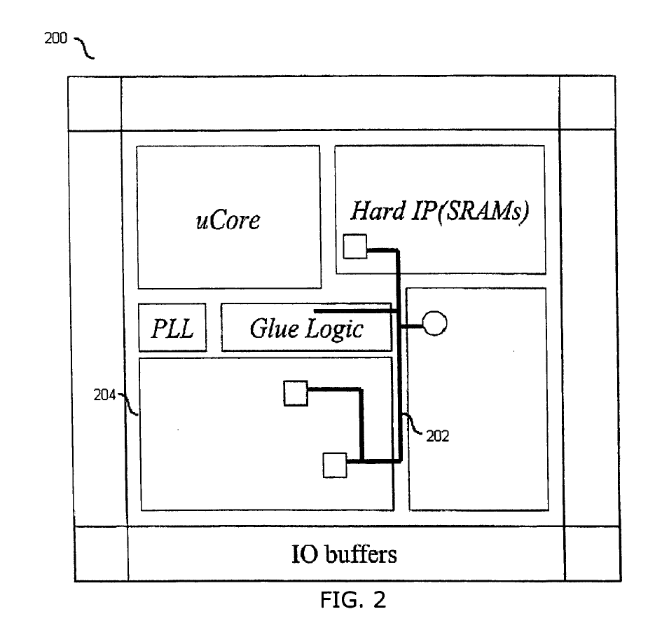

When performing circuit design layout with antenna effect prevention, there are two models can be used according to the present invention. One is referred to as an interface antenna model and the other is abstract antenna model. FIG. 2 illustrates an SOC design layout 200 graphically reflecting the interface antenna model, first of the two different model extraction methods that can be implemented to help speed up the process for determining the cumulative antenna ratio. As a circuit design layout 200 has a number of functional blocks, for the purpose of determining the antenna effect, the internal routing including the metal wires 202 or via shapes are hidden within blocks for the analysis. For example, a block 204 is visible from the top, but all its internal routing information is hidden from the level above the block so that an auto-router software may not identify them during the SoC assembly. It is understood that these blocks can be extracted from a place and route (P&R) database within predetermined design software such as Cadence.

For the purpose of this invention, custom functional modules known as “soft blocks” will be treated as hard modules (also known as IPs) like SRAMs, flash ROMs, hard processor core for both the abstract antenna model and the interface antenna model. Information of the block such as the internal metal ratio for certain layers of metals will have to be extracted from GDSII files which are a standard layout format. Using the interface model, a top-level layout can be verified for the antenna effect in a rather early stage without verifying the whole chip layout down to each layer, thereby avoiding late surprise and saving layout iteration. If the verification produces any design rule violations, they can be fixed quickly.

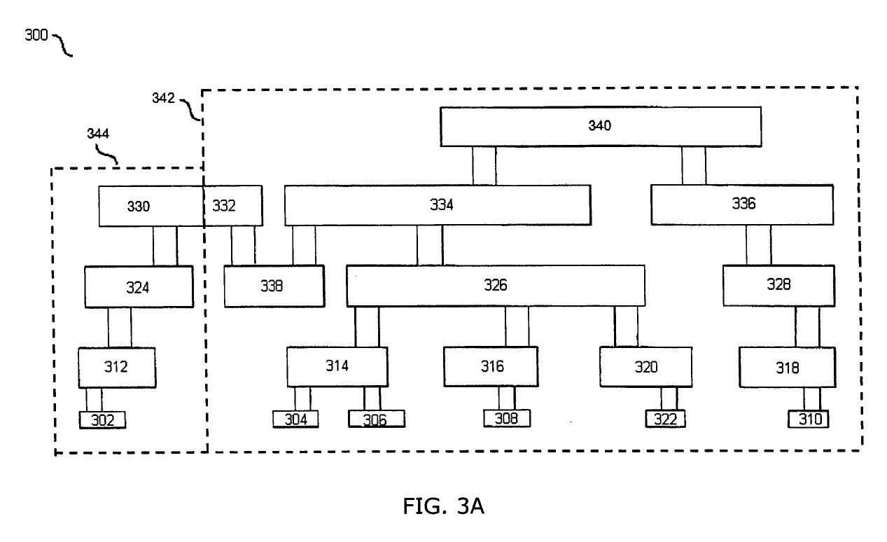

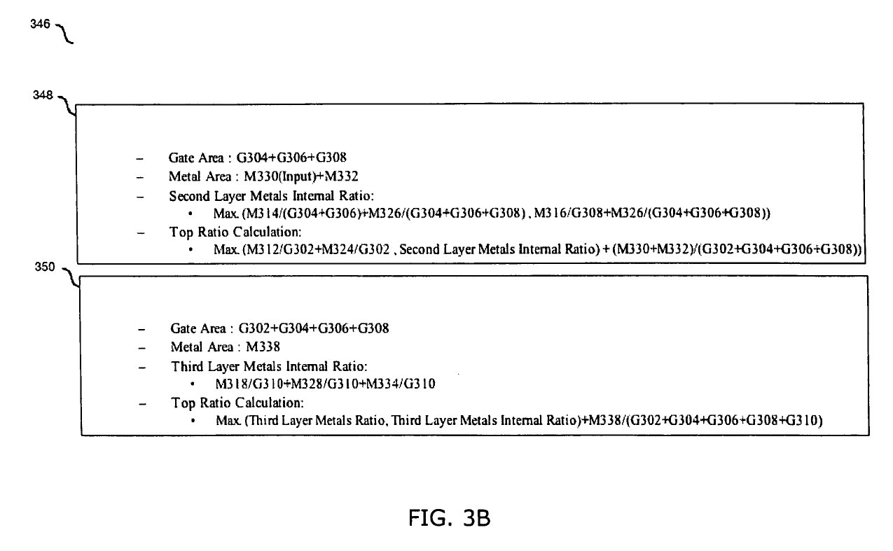

FIG. 3A presents a diagram 300 showing another copper structure made by copper process of 0.13 um, 90 nm, or below where the interface model 200 of FIG. 2 is also implemented at the analysis stage at the top level.

The diagram 300 is similar to the diagram 100 in that it includes 5 separate gates 302, 304, 306, 308, and 310, each of which connects to one of the first layer metals 312, 314, 316, and 318. A first layer metal 320 is connected to a diffusion region 322. Each of the first layer metals 312, 314, 316, 318, and 320 is then connected to one of the second layer metals 324,326, and 328, each of which is further connected to one of the third layer metals 330, 332, 334, and 336. The third layer metals 332 and 334 are tied directly to each other through a second layer metal 338, while both the third layer metals 334 and 336 are also connected to a fourth layer metal 340. Since the interface model 200 is implemented at the analysis stage at the top level for the copper process, parts of the copper process will be hidden within a block 342. In other words, all metal layers, gates, and metal wires will be hidden by the block 342 during the SoC chip assembly and will not be seen by any auto-router. The top level of the copper process as embodied in the diagram 300 is represented in a block 344, meaning that the gate 302, the first metal layer 312, the second metal layer 324, and the third metal layer 330 can not be seen from outside. The third layer metals 330 and 332 are the same piece of metal, and they are separated into input section represented by the third layer metal 332 and output section, which is represented by the third layer metal 330.

As the copper process continues to shrink in size, model extraction algorithms will be more complicated, thereby making calculation of antenna effect more difficult. By implementing the interface model 200 at the analysis stage at the top level, a new improved and simplified method for calculating the cumulative antenna ratio is possible.

FIG. 3B illustrates another embodiment of the present invention with a diagram 346 showing an improved and simplified method for determining cumulative antenna ratio for the copper structure in FIG. 3A by using an abstract model that can be used at the implementation stage. The abstract model in the diagram 346 can simplify the complicated model extraction algorithms resulted from calculation of cumulative antenna ratio demonstrated in the diagram 140 of FIG. 1B since some of the information such as internal metal layer ratios are hidden within the block 344 of FIG. 3A. By plugging in hidden internal information from the block for top ratio calculations, the same calculation as one in an “exposed” chip can be achieved. Comparing the more graphical interface model shown in FIG. 2, the abstract model shown in FIG. 3B is more in a “number” format.

First, the antenna ratio for each metal layer is saved as an internal ratio, and then passed on to the next layer so equations for each layer remains around the same length and never gets too complicated. As shown in equation sets 348 and 350, top ratio calculations for both the third layer metals and fourth layer metals remain relatively short compared with the equation sets 146 and 148 of FIG. 1B. It is noted that the first and second layer metals will not be seen from outside. For example, since the block 342 and 344 is “visible” at the third metal layer, the antenna ratio is considered from this layer to start with. As shown in the equation set 348, from the perspective of the metal 332, the gate areas involved are 304,306, and 308 while the route under the metal structure 336 is not relevant at the point because it only connects to the metal structure 334 through the fourth metal layer. The metal areas involved are, from the perspective of the metal structure 330/332, M330 and M332. However, the ratio for the immediately lower metal layer needs to be considered for calculating the current layer. So, a Second Layer Metals Internal Ratio (SLMIR) is determined by examining the ratio in an accumulative fashion. It is noted again that only the larger of the two routes under the metal structure 326 is used as the SLMIR. With the SLMIR, the two routes under the metal structure 330/332 are easy to be determined as, for example, one being represented by M312/G302+M324/G302, and the other being represented by the SLMIR. The accumulative ratio for the third layer can be derived by adding the greater one of the two with the ratio between the metal structure 330/332 with regard to all gates thereunder, as represented by (M330+M332)/(G302+G304+G306+G308) and may be referred to as a “blanket ratio”. The obtained accumulative antenna ratio can be used for calculation for the upper metal layer antenna ratio as illustrated in the equation set 350. For the purpose of illustration, this ratio for the third metal layer is referred to as the Third Layer Metals Ratio (TLMR). For the fourth metal involved, since the route under the metal structure 336 is now visible, it is the greater of the TLMR or the Third Layer Metals Internal Ratio (TLMIR) to be combined with the blanket ratio of M340/(G302+G304+G306+G308+G310).

In short, the accumulative antenna ratio is better than the per-layer antenna ratio for advanced metal processes with small dimensions. The abstract model in the diagram 346 allows antenna ratio calculation to be performed as one in a flatten chip. As for the hierarchical layout, the discrepancy in antenna report between place and route, and design rule check tools sign-off can be reduced resulting in reduction in layout iteration. With both abstract models in the diagram 346 and the interface model of FIG. 2, antenna effect prevention for copper process in 0.13 um, 90 nm, and below is possible.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for determining an antenna ratio for an interconnect in a circuit, the interconnect being routed through one or more connection layers and being electrically coupled to one or more gate oxide areas, the method comprising:
determining a cumulative antenna ratio for all components on each connection layer by considering an antenna effect caused by each component on a predetermined connection layer with regard to the gate oxide areas coupled thereto and any components on one or more connection layers coupled between the component of the predetermined connection layer and the gate oxide areas; and
calculating a top layer cumulative antenna ratio for the interconnect based on the cumulative antenna ratios.

2. The method of claim 1 wherein the determining a cumulative antenna ratio further includes:
determining one or more gate oxide areas coupled to a predetermined component on the predetermined connection layer;
determining one or more connection routes between the predetermined component and the gate oxide areas; and
determining a cumulative antenna ratio for each connection route, wherein a largest cumulative antenna ratio among the determined cumulative antenna ratios for all the connection routes is the cumulative antenna ratio for the predetermined component.

3. The method of claim 1 further comprising determining a number of connection layers involved with the interconnect.

4. The method of claim 1 further comprising determining antenna ratios for components of the interconnect on each connection layer with regard to one or more gate oxide areas coupled thereto.

5. The method of claim 1 wherein the antenna ratio for the interconnect is calculated for one or more functional blocks of the circuit.

6. The method of claim 1 further comprising examining the antenna ratio for the interconnect and adjusting a layout of the circuit for reducing the antenna ratio if it violates a predetermined rule.

7. The method of claim 6 wherein the examining and adjusting are carried out by a design rule check program.

8. A method for determining an antenna ratio for an interconnect in a circuit block, the interconnect being routed through one or more connection layers and being electrically coupled to one or more gate oxide areas, the method comprising:
identifying a first connection layer on which a pin of the block is coupled to the interconnect;
determining a cumulative antenna ratio for all components of the interconnect with regard to the first connection layer by considering an antenna effect caused by each component on the first connection layer with regard to the gate oxide areas coupled thereto and caused by any components on one or more connection layers coupled between the component of the first connection layer and the coupled gate oxide areas; and
calculating one or more cumulative antenna ratios with regard to one or more connection layers above the first connection layer in the same fashion as determining the cumulative antenna ratio for the first connection layer until a cumulative antenna ratio for a top most connection layer is obtained, wherein the cumulative antenna ratio for the top most connection layer is the antenna ratio for the interconnect.

9. The method of claim 8 wherein the determining the cumulative antenna ratio further includes:
determining one or more gate oxide areas coupled to a predetermined component on the first connection layer;
determining one or more connection routes between the predetermined component and the gate oxide areas; and
determining a cumulative antenna ratio for each connection route, wherein a largest cumulative antenna ratio among the determined cumulative antenna ratios for all the connection routes is the cumulative antenna ratio for the predetermined component.

10. The method of claim 8 further comprising examining the antenna ratio for the interconnect and adjusting a layout of the circuit for reducing the antenna ratio if it violates a predetermined rule.

11. The method of claim 10 wherein the examining and adjusting are carried out by a design rule check program.

12. A method for determining an antenna ratio for an interconnect in a circuit, the interconnect being routed through one or more connection layers and being electrically coupled to one or more gate oxide areas, the method comprising:
determining a number of connection layers involved with the interconnect;
determining a cumulative antenna ratio for all components on each connection layer by considering an antenna effect caused by each component on a predetermined connection layer with regard to the gate oxide areas coupled thereto and any components on one or more connection layers coupled between the component of the predetermined connection layer and the gate oxide areas, wherein the determining a cumulative antenna ratio for the components on a predetermined connection layer further includes:
determining one or more gate oxide areas coupled to a predetermined component on the predetermined connection layer;
determining one or more connection routes between the predetermined component and the gate oxide areas; and
determining a cumulative antenna ratio for each connection route, wherein a largest cumulative antenna ratio among the determined cumulative antenna ratios for all the connection routes is the cumulative antenna ratio for the predetermined component; and
calculating a top layer cumulative antenna ratio for the interconnect based on the cumulative antenna ratios.

13. The method of claim 12 wherein the antenna ratio for the interconnect is calculated for one or more functional blocks of the circuit.

14. The method of claim 12 further comprising examining the antenna ratio for the interconnect and adjusting a layout of the circuit for reducing the antenna ratio if it violates a predetermined rule.

15. The method of claim 14 wherein the examining and adjusting are carried out by a design rule check program.

16. The method of claim 12 wherein the determining a cumulative antenna ratio for all components on each connection layer further includes determining one or more antenna ratios for components of the interconnect on each connection layer with regard to one or more gate oxide areas coupled thereto.
